(19) United States
(12) Patent Application Publication
(10) Pub. No.: US 2003/0014394 A1
(43) Pub. Date: Jan. 16, 2003

(54) Cell-level data access control using user-defined functions

(76) Inventors: Shinji Fujiwara, Cupertino, CA (US); James Lochowitz, Palatine, IL (US); Michelle L. Kehrer, Plainfield, IL (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/816,640

(22) Filed: Mar. 22, 2001

(51) Int. Cl. G06F 7/00

(52) U.S. Cl. 707/3

(57) ABSTRACT

Access control at the cell level is provided by the use of mask functions. Original queries are modified to contain mask functions for those cells which controlled access in accordance with an access policy is desired. In addition, filter functions are included to eliminate rows according to the access policy

### BACKGROUND OF THE INVENTION

The present invention relates generally to database access and in particular to controlled access to fields in a database.

Today's information technology enables one to experience seamless access to various kinds of data sources. Such technology makes accessible to people increasingly greater amounts of information. However, data sources often contain critical information such as medical records, financial records, and other similar personal information which should be protected from unauthorized access, requiring access privilege of those who desire to access such information. Database systems have evolved to provide a set of data access control functions using view definitions and authorization models.

A view is an information object that allows you to view data in a normal table, but in a different way. It is a logical dynamically defined table comprised of portions of the fixed tables which constitute the database. Views provide a method for looking at data in the underlying tables without having to duplicate the data.

The traditional view can control access to data in the database on either a row-level and/or a column level basis. FIG. 1 shows an example of hospital data INPT_BASE 100 that contains inpatient information and aggregated inpatient information grouped by MD_ID. Assume that each physician is permitted only to see his/her patient visit. FIG. 2 shows the desired views of INPT_BASE 100 for each physician. The PT_ID, VST, P_NM and MD_ID fields are selectively made invisible to protect the privacy of each patient so physicians can only see data for their own patients. Thus, for the doctor whose ID is 2222, the view that should be available to that doctor is the view 202. For the doctor whose ID is 3333, the view is view 204.

A view for the inpatient table can be defined by a conventional view definition (or view creation). For example, FIG. 3 shows a view definition that produces the views 202, 204, 206 shown in FIG. 2. (Note that user-id can be replaced with an expression that returns the current user-id, e.g., SYS_CONTEXT(‘userenv’, ‘session_user’), in the case of an Oracle database system.) However, if we execute the SQL statement in FIG. 4 to get the aggregated inpatient information grouped by MD_ID, each physician will get different results such as shown in FIG. 5.

To get the desired aggregation result shown in FIG. 2, we can define a view shown in FIG. 6. However, we must define all possible combinations of aggregation views to allow ad-hoc multi-dimensional analysis. This brute force approach greatly increases the view maintenance cost significantly. For example, if a physician wants to see the statistics of specific a DRG (Diagnostic Related Group) e.g., DRG BETWEEN 120 and 129, then we must define a view that aggregates the subset of data grouped by MD_ID separately. Since each physician may want to see a different subset of data, it is almost impossible to prepare this view beforehand.

Current systems solve this issue by implementing access-control policies as a part of the application logic. However, there are multiple applications in a typical system. Consequently, an access policy would have to be implemented in each of the different applications, a task which significantly increases the maintenance cost of the access policy. In cases where legacy software is being used, the effort may be completely frustrated.

Database protection can be obtained through a variety of security measures including: flow, inference, and access control. Access controls in information systems are responsible for ensuring that all direct access to the system object occurs exclusively according to the models and rules fixed by protection policies. Access controls are enhanced to a content-dependent access control model for database systems. In the conventional view definition based on content-dependent access control model, an access rule can be represented by the tuple (s, o, t, p), which specifies that a subject s has access t to those occurrence of object o for which predicate p is true. An enhancement of the model comprises a six tuple (a, s, o, t, p, f), where a is an authorizer subject who granted s the right (o, t, p), while f is a copy of a flag describing the possibility for s to further transfer (o, t, p) to other objects.

Many security models have been proposed in the prior art literature. The Access Matrix model, Take-Grant model, Action-Entity model, and Wood et al. model are discretionary security models. A user query is checked against the authorizations. If it is allowed, the query accesses the object in a specific access mode. Otherwise the access is denied.

In a paper by Lunt, T. F., Denning, D., Schell, R. R., Heckman, M., and W. R. Shockley, entitled “The Sea View Security Model,” IEEE Trans. on Software Engineering, Vol. 16, No. 6 (Jun. 1990), pp. 593-607, a security model known as the Sea View model was proposed to protect security of relational database systems by using two layers: Mandatory Access Control (MAC) model and Trusted Computing Base (TCB) model. Sea View controls multilevel data access by generating virtual multi-level relation instances from physical single-level relations.

Other models include Jajodia-Sandhu's model and Smith-Winslett's model which have been proposed as multilevel security models. Security policies for these models generate virtual multi-level relation instances. These models use a commutative filter that is placed between a database system and applications to implement database security.

Processing a conventional view includes the following typical steps:

1) Authentication.

2) Apply view definitions, i.e., rewrite a query according to view definitions.

3) Optimize the query.

4) Execute the query.

5) Return results.

In the conventional view, access control rules are applied to a query before execution. The query cannot access a column that is not a member of the projection columns. Furthermore, if a user defines a function that blinds the column value as a projection object, the query cannot access the original value either.

Ferraiolo, David F., Barkley, John F., and Kuhn, D. Richard, in a paper entitled “A Role-Based Access Control Model and Reference Implementation Within a Corporate Intranet,” Trans. Inf. Syst. Secur. 2, 1 (Feb. 1999), pp. 34-64, describe a role-based access control that gives access privileges based on the concept of user-roles.

The Oracle8i system has a fine-grain access control using a virtual private database, which is discussed in a white paper by Davidson, Mary A., entitled “Creating Virtual Private Databases with Oracle8i,” Oracle Magazine, (July 1999). This function enables a database designer to add a selection condition string automatically whenever a user accesses the table. The condition string can be generated based on any value, e.g., context values and session values. However, the condition eliminates the rows that do not satisfy it, and so we cannot mask a subset of the columns in a row.

A security model has been proposed for statistical database systems to prevent statistical inference, in a paper by Chin, F. Y., entitled “Security in Statistical Databases for Queries with Small Counts,” ACM Trans. Database System, 3, I (Mar. 1978), pp. 92-104. There are three techniques for inference protection, i.e., conceptual, restriction-based, and perturbation-based techniques, see for example “Database Security,” by Castano, Silvana, Fugini, Mariagrazia G., Martella, Giancarlo, and Samarati, Pierangela, Addison-Wesley Publishing Company, (1994) and a paper by Adam, Nabil R. and Worthmann, John C., entitled “Security-control Methods for Statistical Databases: A Comparative Study,” ACM Comp. Surveys, Vol. 21, No. 4, (Dec. 1989), pp. 515-556. These techniques suppress the statistical values or restrict a combination of group dimensions. However, the techniques do not provide a function that suppresses a dimension value itself. Therefore, they cannot define an access policy for aggregation results such as shown in FIG. 2.

There is a need for flexible cell-level data access control technique based on access policy. An access policy implementation is needed which can reduce system costs.

### SUMMARY OF THE INVENTION

The present invention provides cell-level access control using mask functions for each access controlled column. Each mask function is associated with one or more key parameters which determine the access permission. The mask function returns a masked column value or an original column value, depending on the access policy embodied in the mask function.

Another aspect of the present invention provides cell-level access control using filter functions for each row elimination policy. Each filter function is associated with one or more key parameters. The filter function returns a two-category (e.g. binary) value. A condition for checking return value of the filter function is added to a condition clause in a query to eliminate rows in accordance with the row elimination policy.

Still another aspect of the invention is a reporting system which provides the foregoing cell-level access control mechanisms.

### BRIEF DESCRIPTION OF THE DRAWINGS

The teachings of the present invention can be readily understood by considering the following detailed description in conjunction with the accompanying drawings:

FIG. 1 illustrates an example of a data organization for hospital-related data;

FIG. 2 illustrates the views of the data shown in FIG. 1, typically required by physicians;

FIG. 3 shows a view definition which produce the views shown in FIG. 2;

FIG. 4 shows a SQL statement with aggregation;

FIG. 5 shows the result of an aggregation inquiry on a view defined by a conventional view definition;

FIG. 6 shows a prior art view definition with aggregation;

FIG. 7 shows web-based reporting system architecture which can be adapted with the present invention;

FIG. 8 illustrates a typical example of a data access policy;

FIG. 9 shows an illustrative example of a table schema in a database system;

FIG. 10 shows an example template of a mask function according to the invention;

FIG. 11 illustrates an SQL prior to modification;

FIG. 12 shows an overview of the cell-level access control architecture in an embodiment of the invention; and

FIG. 13 illustrates how changes to the access policy can be readily accommodated in the present invention.

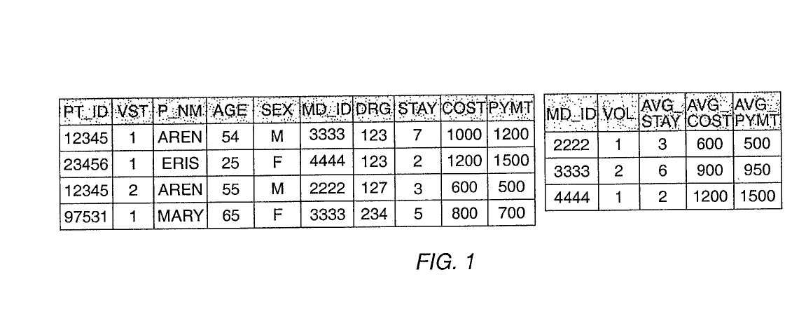

### DESCRIPTION OF THE SPECIFIC EMBODIMENTS

Referring to FIG. 7, an embodiment of the present invention can be described in connection with a web-based reporting system architecture 700. The architecture comprises three server components: A database server 722 includes a database management system (DBMS) 702. The DBMS can be any conventional database system. In one particular illustrative embodiment, the DBMS is a relational database system. A report server 706 is in communication with the database server over conventional communication facilities, the specifics of which depend on the particular embodiment of the invention. The report server includes a plurality of report templates 734 to facilitate its function of providing report generating services. A web server 704, in communication with the report server, provides client-side access to the DBMS. The web server communicates with the report server over conventional communication facilities, the specifics of which depend on particular embodiment of the invention.

FIG. 7 shows a typical software and hardware configuration of the server components. The database server 722 typically occupies its own computer system, including a high capacity storage subsystem. The report server 706 and the web server 704 are shown residing in another computer system 734, separate from the database server. In practice, the web server and the report server may be comprised of multiple instantiations of web server processes and report server processes to achieve a desired throughput. It is noted that many alternative configurations are possible; e.g., a single computer system can be used to host all three servers components in a small scale operation. In a large installation, each server my occupy its own computer system. Each server may in fact comprise multiple server systems in very large systems in order to provide even greater throughput.

User access to the DMBS 702 is made via a browser client 712, executing on yet a third computer system 726. The browser communicates with the web server 704 using the hypertext transport protocol (HTTP) or HTTP over SSL protocol (HTTPS).

A user will interact with the web server 704 via the browser 712 to obtain a report. First, a report template 734 is selected. Next, a set of parameters for the template is provided. The web server passes a template identifier corresponding to the user-selected report template along with the user-provided parameters to the report server 706. The report server issues one or more queries associated with the selected report template to the database server 722. After some appropriate interactions between the report server and the database server, the results of the query(ies) are returned to the report server. The report server receives the results and formats them into a presentable form which is then delivered to the user through the web server.

FIG. 8 is an example of a simple data access policy shown merely for illustrative purposes. In this example, assume that three access levels are desired: executive level; medical doctor level, and financial analyst level. An executive level user is allowed to access all of the data. Typically, this systemis for administrator personnel and database management personnel.

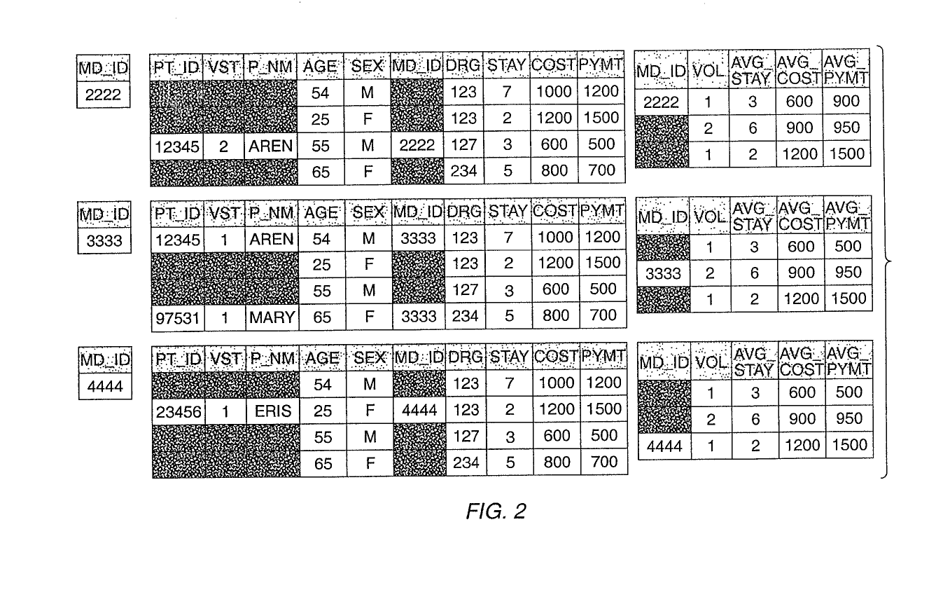

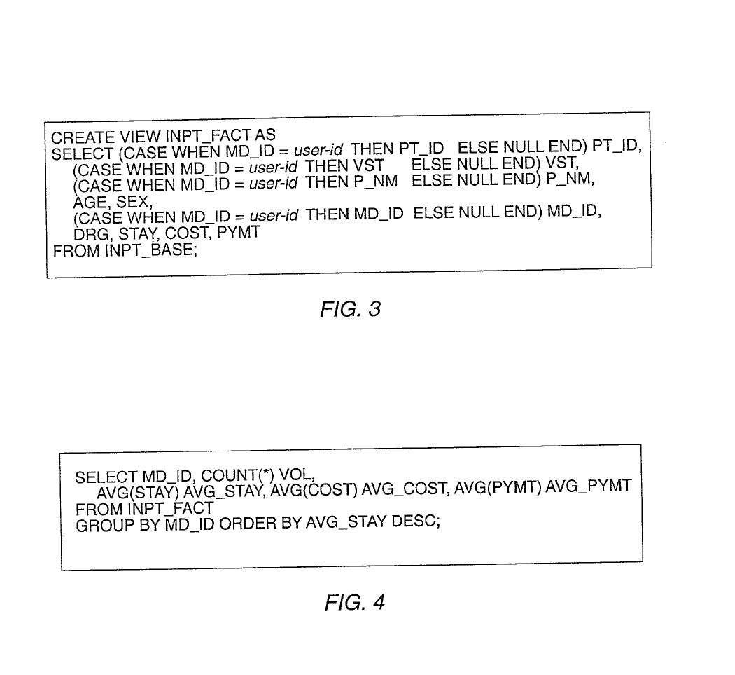

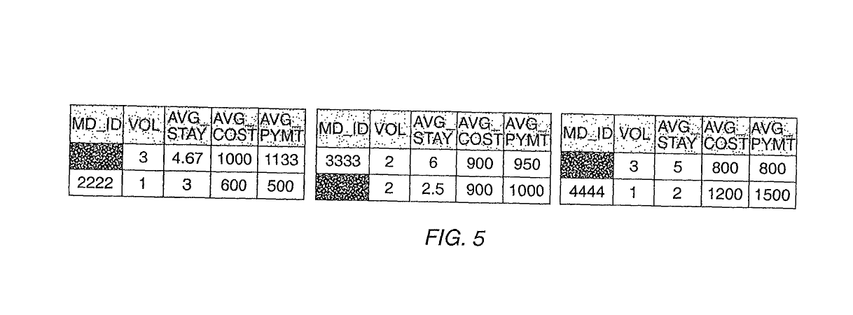

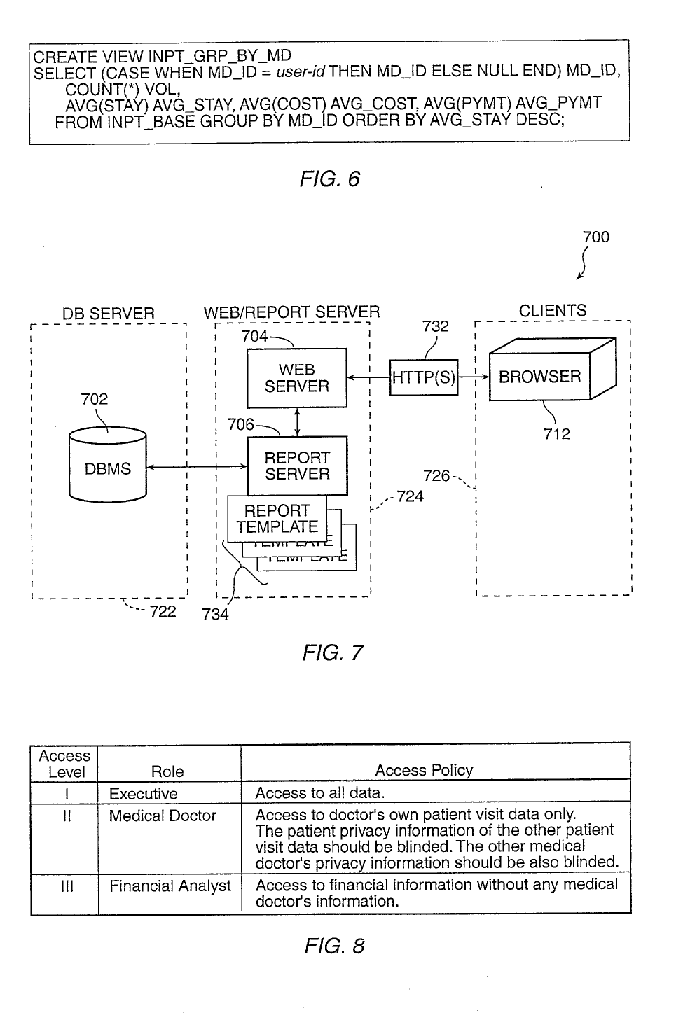

A physician would be accorded the privileges of a medical doctor-level user. The physician should be able to access patient data relating to treatment of the patient visit, and data that the physician generates. However, the physician is not allowed to access certain of the patient's private information; e.g. credit card information. Furthermore, a physician is not allowed to access the data of another physician. According to the illustrative access policy described in FIG. 8, a physician cannot see the patient name for the patient visits that were treated by the other physician, even if the physician treated the patient's other visit. For example, physician 2222 cannot see the patient name for the first row in FIG. 2, since the other physician 3333 treated AREN's first visit. Therefore, according to the illustrative access policy given in FIG. 8, even though the physician 2222 treated AREN's second visit, that physician cannot see the name for AREN's first visit. It is understood that there are other access policies which allow access to the data in such a case. It is understood that the present invention can provide for such access policies.

Finally, access control is provided for financial personnel. This class of user is given financial analyst level user access. The financial analyst can access financial information such as stay, cost, and payment, including certain of a patient's financial information. However, a financial analyst should not have access the kind of data needed by a physician.

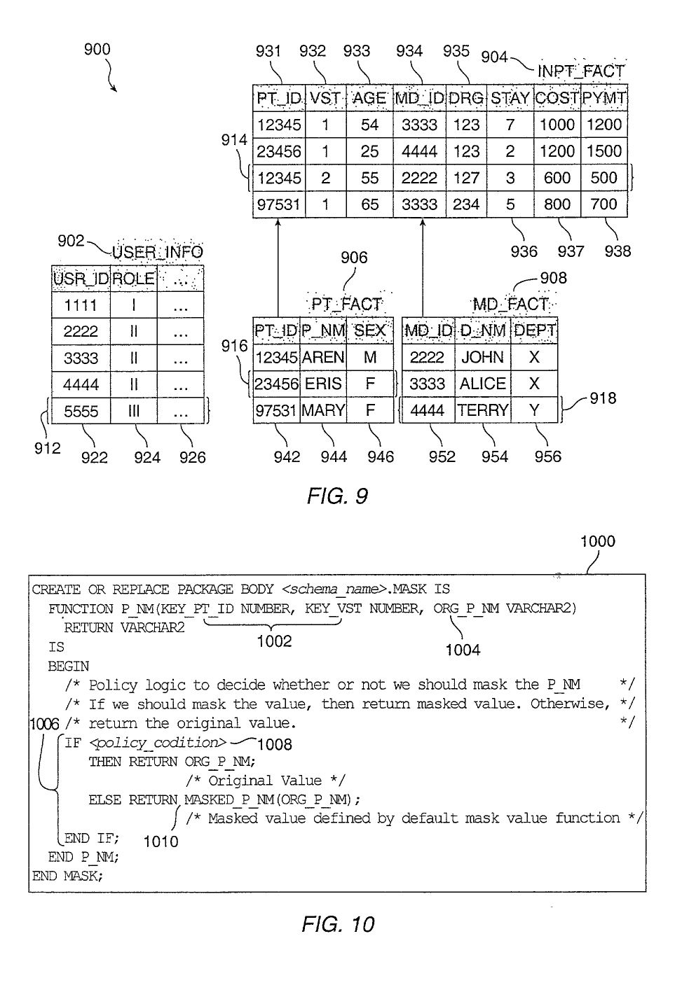

Referring to FIG. 9, a illustrative example of a data schema 900 for the relational DBMS 702 (FIG. 7) is shown. A user information table 902 (USER_INFO) contains a user record (e.g., user record 912 ) for each user. Each record includes a user-id field 922 and a role field 924, in addition to other user-related information 926. The role field identifies the access level privileges for each user, per the access policy of FIG. 8.

An inpatient information table 904 (INPT_FACT) maintains an inpatient record (e.g. inpatient record 914) for each visit made by a patient. Consequently, a patient is very likely to have multiple entries in this table, one for each visit. A patient-id field 931 identifies the patient. A patient-visit field 932 (VST) indicates each visit/admission occurrence of a patient. Another field is the medical doctor ID field 934, which contains an identifier of the treating physician.

A patient information table 906 (PT_FACT) contains a patient record for each patient. Each record includes a patient-id field 942 (PT_ID), a patient name field 946 (P_NM), and a patient-sex field 946 (SEX). A similar physician information table 908 (MD_FACT) contains information for each physician. This might include, for example, a medical doctor ID field 952 (MD_ID), a name field 954 (D_NM), and a medical doctor department field 956 (DEPT).

Referring now to FIGS. 8 and 9, the effect of the access policy as it relates to the data schema 900 will be described. Consider, for example, role II users. Recall that a role II user is a physician. A physician should only be able to view certain information for only those patients treated by that physician. Thus, it can be seen that the patient age field 933, the DRG field 935, the length of stay field 936, the cost field 937, the payment field 938, the patient-sex field 946, and the medical doctor department field 956 can be viewed by the treating physician. However, the patient-id field 931 and 942, the patient-visit field 932, the patient-name field 944, the medical doctor ID field 934 and 952, and the medical doctor name field 954 should not be available to a physician if that patient visit was not treated by that physician or if that information is the physician's own data (e.g., a physician can see his name). Thus, the result of inquiries to the schema 900 should include all data for those patient visits that were treated by the inquiring physician, and partially masked data for those patient visits that were not treated by the inquiring physician.

The access policy for a role II user as shown in FIG. 8 restricts the access to the patient private information such as PT_ID, VST_NBR, and P_NM by a patient visit (not by a patient). Therefore, the key set to determine whether the patient private information should be masked or not is the column set {PT_ID, VST_NBR}, since these columns are primary keys for the patient visit object. (If the access policy restricts the access by a patient, the key set is {PT_ID}). As for medical doctor information, a role II user can only access his/her own privacy information. Therefore, the MD_ID, and D_NM will be blinded if it is not his/hers. Therefore, the key set to determine whether the physician's private information MD_ID and D_NM should be masked or not is the column set {MD_ID}.

If a role II user issues the query such as: SELECT * FROM PT_FACT; then, all PT_ID, and P_NM columns should be blinded (masked), because a role II user should not get the patient list in the hospital. A role II user can only make his/her own patient list. To make his/her own patient list he should issue the following query: SELECT DISTINCT a.PT_ID, a.P_NM, a.SEX FROM PT_FACT a, INPT_FACT b WHERE a.PT_ID=b.PT_ID and b.MD_ID physician 's-id. In this case, we can determine whether the columns PT_ID and P_NM should be masked or not by using the value of {PT_ID, VST_NBR}, since the query joins the PT_FACT and INPT_FACT. In conclusion, we will not allow to be seen the private data if the key columns of the objects to determine the mask are not covered by the tables in the query.

To implement above access control policy, the present invention provides mask functions for each column. Thus, if the access policy denies access to a column under certain conditions, that column should be masked (blinded). In accordance with the invention, a mask function is therefore provided for that column. Note that if a column is not blinded in current access policy but may be blinded in the future access policy, we can also provide a mask function for the column.

FIG. 10 shows an illustrative example of a mask function 1000 for the patient name column, P_NM. In accordance with an embodiment of the invention, mask functions are defined by conventional SQL-type syntax for user-defined function calls, sometimes referred to as “stored procedures”, “a procedure call”, and so on. It is understood that the idea of a mask function may be implemented in other ways. For example, the SQL language can be redefined to include mask function capability. The use of user-definable functions, however, has the advantage of not having to provide for a custom SQL language.

The mask function 1000 includes an associated set of one or more key parameters 1002. The mask function also has an associated original value parameter 1004. As will be explained, the one or more key parameters form the basis for deciding whether a masked column will be displayed or whether it will be masked. In the example shown in FIG. 10, there are two key parameters: KEY_PT_ID and KEY_VST (1002) in the mask function for P_NM 1000, since the access policy for a role II user requires to protect patient private information by patient visit, and PT_ID and VST is a key column for the patient visit object.

The mask function includes an IF-THEN-ELSE clause 1006. The IF condition constitutes access policy condition logic 1008, which is defined in accordance with the access policy in effect. The access policy condition logic is a function of the key parameters 1002. If the access policy condition evaluates to TRUE, then the mask function returns the original value parameter 1004 as the column value. If the access policy condition evaluates to FALSE, a default value is returned as the column value.

In the embodiment of the invention shown in FIG. 10, the default value is produced by a function call 1010. In this particular illustrative example, the default value is some function of the original value parameter 1004. In another embodiment, the default value may be based on information not limited to the original value parameter. In yet another embodiment of the invention, the default value can be a fixed output; e.g. NULL, or a text string such as “Unauthorized Access”, and so on. The operating conditions, security considerations, and the like will determine how the default value would be determined.

In a general form, a mask function according to one embodiment of the invention has the following syntax:

rv←mask_name(kp₁, kp₂, . . . kpₙ, op),

where rv is the return column value of the mask function,

kp₁, kp₂, . . . kpₙ are the key parameters used to determine whether masking occurs, and

op is the original value of the masked column.

The specific syntax of the function call and its definition will vary from one SQL implementation to another. Such details are known and understood by those of ordinary skill in the database art.

Table I below is an example of a typical mask function according to the invention. Also shown is a filter function according to the present invention.

TABLE I

| | |
|---|---|
| /* = = = = = = = = = = = = = = = = = = = = = = = = = = = = = = = = = = = = = = = = = = = = = = = = = | */ |
| /* PACKAGE MASK | */ |
| /* = = = = = = = = = = = = = = = = = = = = = = = = = = = = = = = = = = = = = = = = = = = = = = = = = | */ |
| CREATE OR REPLACE PACKAGE FINVIEW.MASK AS | |

FUNCTION P_NM(KEY_PT_ID NUMBER, KEY_VST NUMBER, ORG_P_NM

VARCHAR2)

RETURN VARCHAR2;

FUNCTION D_NM(KEY_MD_ID NUMBER, ORG_D_NM VARCHAR2)

RETURN VARCHAR2;

END MASK;
CREATE OR REPLACE PACKAGE BODY MASK IS

FUNCTION P_NM(KEY_PT_ID NUMBER, KEY_VST, ORG_P_NM VARCHAR2)

RETURN VARCHAR2

IS
BEGIN

IF FILTER.PT(KEY_PT_ID, KEY_VST)=1 THEN

RETURN ORG_P_NM;

ELSE

RETURN MASKED.P_NM(ORG_P_NM);

END IF;

END P_NM;
FUNCTION D_NM(KEY_MD_ID NUMBER, ORG_D_NM VARCHAR2)

RETURN VARCHAR2

IS
BEGIN

IF FILTER.MD(KEY_MD_ID)=1 THEN

RETURN ORG_D_NM;

ELSE

RETURN MASKED.D_NM(KEY_MD_ID, ORG_D_NM);

END IF;

END D_NM;

| END MASK; | |
|---|---|
| /* = = = = = = = = = = = = = = = = = = = = = = = = = = = = = = = = = = = = = = = = = = = = = = = = = | */ |
| /* PACKAGE FILTER | */ |
| /* = = = = = = = = = = = = = = = = = = = = = = = = = = = = = = = = = = = = = = = = = = = = = = = = = | */ |
| CREATE OR REPLACE PACKAGE FILTER AS | |

FUNCTION PT(KEY_PT_ID NUMBER, KEY_VST NUMBER)

RETURN NUMBER;

FUNCTION MD (KEY_MD_ID NUMBER, KEY_VST NUMBER)

RETURN NUMBER;

END FILTER;
CREATE OR REPLACE PACKAGE BODY FILTER IS

FUNCTION PT (KEY_PT_ID NUMBER, KEY_VST NUMBER)

RETURN NUMBER

IS

| | |
|---|---|
| CNT | NUMBER; |

BEGIN

| | |
|---|---|
| /* − − − − − − − − − − − − − − − − − − − − − − − − − − − − − − − − − − − − − − − − − − − − − − − − − | */ |
| /* FOR USER_ROLE_TYP=1 | */ |
| /* − − − − − − − − − − − − − − − − − − − − − − − − − − − − − − − − − − − − − − − − − − − − − − − − − | */ |
| IF SYS_CONTEXT(′SECURITY′, ′ROLE_1′) = 1 THEN | |

RETURN 1;

| END IF; | |
|---|---|
| /* − − − − − − − − − − − − − − − − − − − − − − − − − − − − − − − − − − − − − − − − − − − − − − − − − | */ |
| /* FOR USER_ROLE_TYP = 2 | */ |
| /* − − − − − − − − − − − − − − − − − − − − − − − − − − − − − − − − − − − − − − − − − − − − − − − − − | */ |
| IF SYS_CONTEXT(′SECURITY′, ′ROLE_2′) = 1 THEN | |

EXECUTE IMMEDIATE
′SELECT COUNT(*) ′∥
′ FROM ′∥SYS_CONTEXT(′userenv′,

′session_user′) ∥′.ACCS_PTVST ′∥

′WHERE PT_ID = :KEY_PT_ID AND VST=:KEY_VST′
INTO CNT USING KEY_PT_ID, KEY_VST ;
IF CNT > 0 THEN

RETURN 1;

ELSE RETURN 0;
END IF;

| END IF; | |
|---|---|
| /* − − − − − − − − − − − − − − − − − − − − − − − − − − − − − − − − − − − − − − − − − − − − − − − − − | */ |
| /* FOR USER_ROLE_TYP = 3 | */ |
| /* − − − − − − − − − − − − − − − − − − − − − − − − − − − − − − − − − − − − − − − − − − − − − − − − − | */ |
| IF SYS_CONTEXT(′SECURITY′, ′ROLE 3′) = 1 THEN | |

RETURN 1;

END IF;

END PTVST;
FUNCTION MD (KEY_MD_ID NUMBER)

RETURN NUMBER

IS

CNT NUMBER;

BEGIN

| | |
|---|---|
| /* − − − − − − − − − − − − − − − − − − − − − − − − − − − − − − − − − − − − − − − − − − − − − − − − − | */ |
| /* FOR USER_ROLE_TYP = 1 | */ |
| /* − − − − − − − − − − − − − − − − − − − − − − − − − − − − − − − − − − − − − − − − − − − − − − − − − | */ |
| IF SYS_CONTEXT(′SECURITY′, ′ROLE_1′) = 1 THEN | |

RETURN 1;

| END IF; | |
|---|---|
| /* − − − − − − − − − − − − − − − − − − − − − − − − − − − − − − − − − − − − − − − − − − − − − − − − − | */ |
| /* FOR USER_ROLE_TYP = 2 | */ |
| /* − − − − − − − − − − − − − − − − − − − − − − − − − − − − − − − − − − − − − − − − − − − − − − − − − | */ |
| IF SYS_CONTEXT(′SECURITY′, ′ROLE_2′) = 1 THEN | |

EXECUTE IMMEDIATE
′SELECT COUNT(*) ′∥
′ FROM ′∥SYS_CONTEXT (′userenv′,

′session_user′) ∥′.ACCS_MD ′∥

′ WHERE MD_ID = :KEY_MD_ID′ INTO CNT USING KEY_MD_ID;
IF CNT > 0 THEN

RETURN 1;

ELSE RETURN 0;
END IF;

| END IF; | |
|---|---|
| /* − − − − − − − − − − − − − − − − − − − − − − − − − − − − − − − − − − − − − − − − − − − − − − − − − | */ |
| /* FOR USER_ROLE_TYP = 3 | */ |
| /* − − − − − − − − − − − − − − − − − − − − − − − − − − − − − − − − − − − − − − − − − − − − − − − − − | */ |
| IF SYS_CONTEXT(′SECURITY′, ′ROLE_3′) = 1 THEN | |

RETURN 1;

END IF;

END MD;

END FILTER;

The mask function shown is provided merely to illustrate a typical example of an embodiment of the invention. Additional mask functions may be needed depending on the complexity of the database. The specific implementation will depend on the programming language in use. The specific algorithm with vary depending on the specific requirements of the access policy in force. Persons of ordinary skill in the database arts will readily understand how to practice the invention in the context of a particular database system installation.

Table I also shows a filter function which is defined in the FILTER package. Two functions are provided, PT( ) and MD( ). The PTO function has a parameter KEY_PT_ID and KEY_VST. It returns 0 if the data should be masked and returns 1 if the data can be displayed, based on the key parameters and a user role. In this implementation, each role II user has a table PTVST that keeps the list of {PT_ID, VST} for all patient visits that he/she treated.

The MD( ) filter function has a parameter KEY_MD_ID. It returns 0 or 1 in the same way as PT function. MASK functions are defined in the MASK package. This example only includes the mask function for P_NM and D_NM. P_NM mask function first calls the policy function FILTER.PT. Then, if the result is 1, it returns the original value, ORG_P_NM, and if the result is 0, it returns the masked value that is generated by MASKED.P_NM function. D_NM does in the same way as P_NM. Note that we can define any parameters to create masked values. In this example, MASKED.P_NM uses only ORG_P_NM, while MASKED.D_NM uses both KEY_MD_ID and ORG_D_NM.

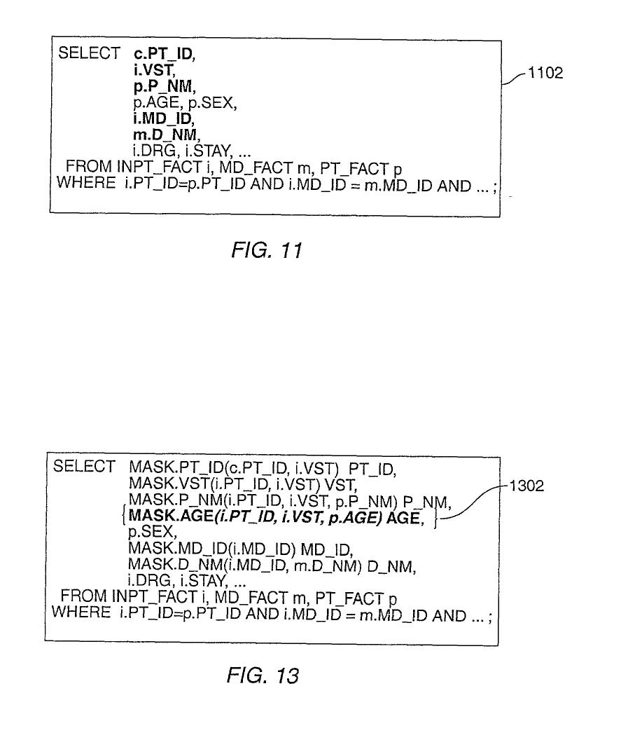

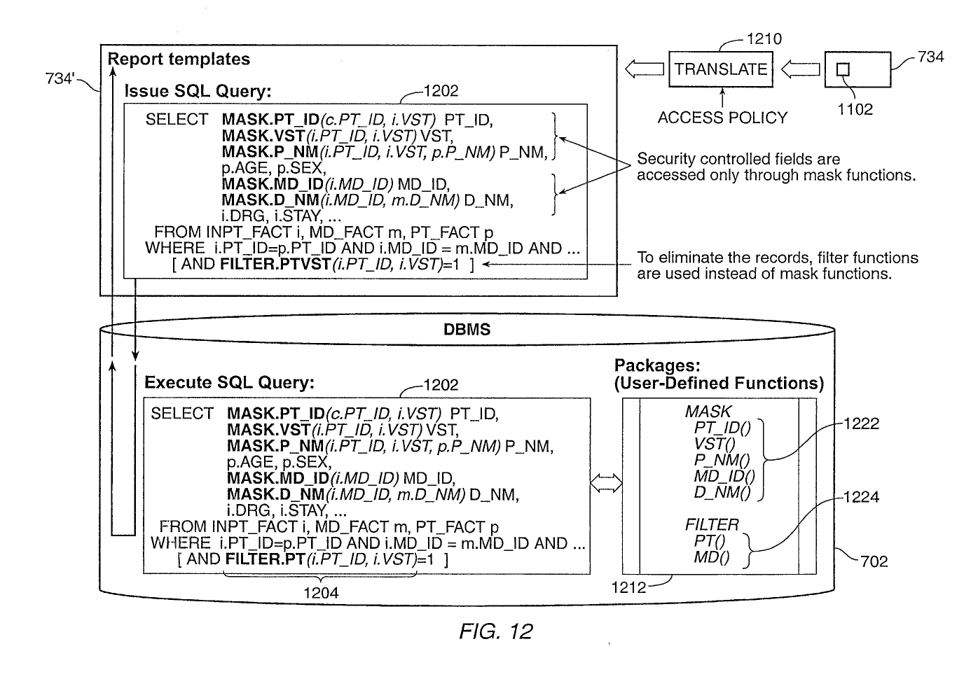

Referring now to FIGS. 11 and 12, an illustrative embodiment of a cell-level access control architecture in accordance with the present invention is shown. FIG. 11 shows a query 1102 that would typically be found in one of the report templates 734 (FIG. 7). The query is written using conventional SQL constructs. A typical SQL query includes a SELECT statement, specifying one or more column references (sometimes referred to as attributes, fields, etc.), which constitute the result of the query.

In accordance with the invention, a translation procedure 1210 is applied to queries comprising the report templates to produce modified report templates 734′.

The queries 1202 comprising the modified report templates are translations of the original queries 1102, wherein certain column references are replaced with mask functions.

The translation procedure 1210 is based on the access policies in effect (e.g., FIG. 8). As can be seen, the original query 1102 is very similar to the translated query 1202. Where the access policy calls for a column reference to be masked, the column reference is replaced with an appropriate function call to a mask function.

Consider the original query 1102, for example. Here, the columns which the access policy requires masking are: PT_ID, VST, P_NM, MD_ID, and D_NM (FIG. 9). Table II below shows the replacement scheme:

TABLE II

| Column Reference | Mask Function Replacement |
|---|---|
| PT_ID | MASK.PT_ID(c.PT_ID, i.VST) PT_ID |
| VST | MASK.VST(i.PT_ID, i.VST) VST |
| P_NM | MASK.P_NM(i.PT_ID, i.VST, p.P_NM) P_NM |
| MD_ID | MASK.MD_ID(i.MD_ID) MD_ID |
| D_NM | MASK.D_NM(i.MD_ID, m.D_NM) D_NM |

Note that the table or view ID should be modified to the appropriate name, according to the FROM clause of each query. For example “c.”, “i.”, “p.”, “m.”, should be modified. As can be seen the translation process 1210 is simply a textual replacement in the original query of the masked column references by their corresponding function calls. The information contained in Table II can be used in conjunction with a text editor to produce the translated query 1202 shown in FIG. 12. The translation process can be a standard editor, e.g., the Unix streaming text editor is especially applicable. The translation process can be a custom piece of software, or even some combination of hardware and software. The translation task called for by the present invention can be provided using any of a number of conventional techniques.

Continuing with FIG. 12, the translation process 1210 converts an original query 1102 into a translated query 1202. The translated query is then transmitted to the DBMS 702, where the query is executed. The DBMS includes a set of user-defined functions 1212. Included in those user-defined functions are the mask function definitions 1222.

FIG. 12 also shows in the user-defined functions a set of filter functions 1224. The filter functions perform in the same manner as the mask functions. Where the mask functions serve to mask out columns in accordance with the access policy, the filter functions serve to mask out rows (records) per a row elimination policy. Filter functions require one or more key parameters that determine whether a row is to be retained or eliminated. In an embodiment of the invention, the filter function returns a binary value such as TRUE/FALSE. It is used in a WHERE clause of an SQL query to limit the rows that are returned in accordance with the row elimination policy. An example of a filter function 1204 is shown in FIG. 12.

The disclosed embodiments are based on relational databases and SQL-type query languages. However, it can be appreciated by a person of ordinary skill in the database art that the mask and filter function approach can be provided in other database systems. In a relational database system, the present invention can provide cell-level data access control with no impact to the underlying database engine.

The translation process 1210 obviates the tedious and error-prone task of modifying existing report templates. The translation process can occur on-the-fly as each query is sent to the database. In another embodiment of the invention, the translation process can be run once (e.g., manually performed by the database administrator) on all of the templates to produce a new set of templates that use the mask and filter functions. This embodiment is attractive from a throughput point of view, since the translation needs to be performed only when a report template is changed. In yet another embodiment of the invention, the translation process can be located at the DBMS 702, intercepting all incoming queries and making the translations on-the-fly. The translation process could be a manually performed task. The specific approach will be determined based on performance criteria, resources, the nature of the use of the database, the number of reports and so on.

Since the mask functions are stored in the DBMS, a change in the access policy amounts to simple re-writing of the mask and filter functions. There is no need to affect the existing application logic. If the access policy changes which columns are to be masked, then the translation process 1210 would be updated accordingly. For example, if we want to add AGE column as a mask column, the original SQL in FIG. 2 might be changed as shown in FIG. 13 by the replacement of the AGE column with a mask function 1302.

Although specific embodiments of the invention have been described, various modifications, alterations, alternative constructions, and equivalents are also encompassed within the scope of the invention. The described invention is not restricted to operation within certain specific data processing environments, but is free to operate within a plurality of data processing environments. Although the present invention has been described in terms of specific embodiments, it should be apparent to those skilled in the art that the scope of the present invention is not limited to the described specific embodiments.

The specification and drawings are, accordingly, to be regarded in an illustrative rather than a restrictive sense. It will, however, be evident that additions, subtractions, substitutions, and other modifications may be made without departing from the broader spirit and scope of the invention as set forth in the claims.

What is claimed is:

1. A method for accessing information in an information store in accordance with an access policy, said method comprising:
receiving an access request comprising a request for a first type of information, wherein said request for a first type of information has associated therewith first information contained in said information store;
replacing said request for a first type of information with a modified request for a first type of information, said modified request being based on said access policy; and
accessing said information store to produce a result in response to said access request, wherein said modified request produces either a masked value or said first information, based on said access policy.

2. The method of claim 1 wherein said modified request includes a mask function.

3. The method of claim 2 wherein said accessing includes executing said mask function to produce either said masked value or said first information.

4. The method of claim 1 further including modifying said access request to include a filter function, said filter function effective for eliminating portions of said result in accordance with said access policy.

5. The method of claim 1 wherein said information store is a relational database and said request for a first type of information comprises a SELECT statement, said SELECT statement comprising one or more column references, said modified request comprising a replacement of at least one of said one or more column references with a mask function.

6. The method of claim 1 wherein said information store is a relational database and said access request includes a WHERE clause, said result comprising one or more rows of information, said method further including incorporating a filter function in said WHERE clause to remove certain rows contained in said result, based on said access policy.

7. In a relational database, a method for accessing information in accordance with an access policy, said method comprising:
providing at least one query comprising a SELECT statement, said SELECT statement comprising one or more column references;
replacing at least one of said one or more column references with a mask function to produce a modified query; and
producing a query result in response to said modified query comprising one or more rows of information;
wherein said query result includes, for said at least one of said one or more column references, either mask values or information from said relational database, based on said access policy.

8. The method of claim 7 wherein said at least one query further comprises a WHERE clause, said method further including modifying said WHERE clause to produce a modified WHERE clause which includes a filter function, said filter function producing one of two logical values, said modified WHERE clause effective for deleting a row from said query result based on a value produced by said filter function.

9. The method of claim 7 wherein said relational database in provided in a database server; said step of providing includes receiving said at least one query at a client system; and said step of producing includes transmitting said modified query to said database server.

10. The method of claim 9 wherein said step of replacing is performed at said client system.

11. The method of claim 9 wherein said step of replacing is performed at said database server.

12. A computer-based information retrieval system comprising:
computer memory having computer readable program code embodied therein for accessing an information store in accordance with an access policy, said computer readable program code comprising:
first code configured to receive an access request for a first type of information, wherein said request for a first type of information has associated therewith first information;
second code configured to replace said request for a first type of information with a modified request for a first type of information, said modified request being based on said access policy; and
third code configured to access said information store to produce a result in response to said access request, wherein said modified request produces either a masked value or said first information, based on said access policy.

13. The system of claim 12 further including fourth code configured to modify said access request to include a filter function, said filter function effective for eliminating portions of said result in accordance with said access policy.

14. The system of claim 12 further including a relational database and said request for a first type of information comprises a SELECT statement, said SELECT statement comprising one or more column references, said modified request comprising a replacement of at least one of said one or more column references with a mask function.

15. The system of claim 12 further including a relational database and said access request includes a WHERE clause, said result comprising one or more rows of information, said second code further configured to incorporate a filter function in said WHERE clause to remove certain rows contained in said result, based on said access policy.

16. The system of claim 12 further including a client computer system and a server computer system, said client computer system comprising a portion of said computer memory embodying said first and second codes, said server computer system comprising another portion of said computer memory embodying said third code.

17. The system of claim 12 wherein said database server is a relational database server, said request for a first type of information comprises a SELECT statement, said SELECT statement comprising one or more column references, said modified request comprising a replacement of at least one of said one or more column references with a mask function.

18. The system of claim 17 wherein said third code includes mask function.

19. The system of claim 16 wherein said database server is a relational database server, said access request includes a WHERE clause, said result comprising one or more rows of information, said second code further configured to incorporate a filter function in said WHERE clause to remove certain rows contained in said result, based on said access policy.

20. The system of claim 19 wherein said third code includes mask function.
